(19) United States
(12) Patent Application Publication
(10) Pub. No.: US 2025/0145411 A1
(43) Pub. Date: May 8, 2025

(54) ELEVATOR SAFETY SYSTEM

(71) Applicant: Otis Elevator Company, Farmington, CT (US)

(72) Inventors: Gérard Sirigu, Gien (FR); Aurélien Fauconnet, Isdes (FR); Alper Caliskan, Gien (FR)

(21) Appl. No.: 18/933,143

(22) Filed: Oct. 31, 2024

(30) Foreign Application Priority Data
Nov. 2, 2023 (EP) 23306897.2

(51) Int. Cl. B66B 5/00; B66B 1/34

(52) U.S. Cl. CPC B66B 5/0056; B66B 1/3461; B66B 5/0081

(57) ABSTRACT

A safety system (105) for an elevator system (100) which includes a hoistway (104), an elevator car (102) and a plurality of landing doors (112a-f). The safety system (105) includes a first safety chain (120), a second safety chain (125) and a controller (110). The first safety chain (120) is configured to produce an even landing signal and the second safety chain (125) is configured to produce an odd landing signal. The controller (110) is configured to automatically instruct the elevator system (100) to enter a special operating mode when the production of the even landing signal and the odd landing signal indicates that the elevator car (102) is located at an even landing and an odd landing door is open, or that the elevator car (102) is located at an odd landing and an even landing door is open.

### FOREIGN PRIORITY

This application claims priority to European Patent Application No. 23306897.2, filed Nov. 2, 2023, and all the benefits accruing therefrom under 35 U.S.C. § 119, the contents of which in its entirety are herein incorporated by reference.

### TECHNICAL FIELD OF INVENTION

The present disclosure relates to systems and methods for ensuring the safety of service personnel while accessing an elevator hoistway.

### BACKGROUND OF THE INVENTION

During elevator service procedures, service personnel are often required to enter the hoistway of an elevator system to access drive systems, lighting systems, sensor systems, call systems and various other components. To do so, service personnel gain entry to the hoistway at a landing above or below the elevator car. When service personnel are in the hoistway and not protected by being inside an elevator car, further protection must be provided.

A variety of safeguards should be provided to the service personnel when they are working in the hoistway. For example, a limit on how close the elevator car can be to the top of the hoistway may be set. Currently, the elevator system in known systems must be put into the service mode manually by the service personnel before they enter the hoistway. Should the service personnel forget to perform this step, or if a non-service personnel person somehow gains entry to the hoistway, serious incidents could occur.

Therefore, there exists a need for a system that automatically switches the elevator system into the service mode before service personnel gains entry to the hoistway.

### SUMMARY OF THE INVENTION

According to a first aspect of the disclosure, there is provide a safety system for an elevator system, the safety system comprising: a first safety chain, a second safety chain and a controller in communication with the first and second safety chains. The elevator system comprises a hoistway, a plurality of landing doors configured to provide access to the hoistway and an elevator car provided in the hoistway. The first safety chain is configured to produce an even landing signal when the elevator car is located at an even landing, and/or when an even landing door located on an even landing is open. The second safety chain is configured to produce an odd landing signal when the elevator car is located at an odd landing, and/or when an odd landing door located on an odd landing is open. The controller is configured to automatically instruct the elevator system to enter a special operating mode when the production of the even landing signal and the odd landing signal indicates that the elevator car is located at an even landing and an odd landing door is open, or that the elevator car is located at an odd landing and an even landing door is open.

By the controller automatically instructing the elevator system to enter a special operating mode when the production of the even landing signal and the odd landing signal indicates that the elevator car is located at an even landing and an odd landing door is open, or that the elevator car is located at an odd landing and an even landing door is open, the likelihood of human error in initiating safety systems is reduced. The overall safety of the entire elevator system is therefore improved. Further, it will be appreciated that in most service situations, service personnel will wish to gain access to the hoistway immediately above or immediately below an elevator car such that an even landing door will be open when the elevator car is located at an odd landing and vice versa.

In some examples, the first safety chain is connected to the controller by a wired connection. In some examples, the first safety chain is connected to the controller by a wireless connection.

In some examples, the second safety chain is connected to the controller by a wired connection. In some examples, the second safety chain is connected to the controller by a wireless connection.

A wired connection can be more reliable than a wireless connection, however a wireless connection may be more cost effective and/or easier to install when larger distances separate the connected components. Therefore, each connection type is useful in different scenarios.

In some examples, the first safety chain comprises an even set of sensors and the second safety chain comprises an odd set of sensors. The even set of sensors are configured to cause the even landing signal to be produced when the elevator car is located at an even landing, and/or when an even landing door is open. The odd set of sensors are configured to cause the odd landing signal to be produced when the elevator car is located at an odd landing, and/or when an odd landing door is open.

In some examples, the even set of sensors comprises a plurality of even door sensors configured to produce an even landing signal when an even landing door is open.

In some examples, the odd set of sensors comprises a plurality of odd door sensors configured to produce an odd landing signal when an odd landing door is open.

In some examples, the even set of sensors comprises a plurality of even landing sensors configured to produce an even landing signal when the elevator car is located at an even landing.

In some examples, the odd set of sensors comprises a plurality of odd landing sensors configured to produce an odd landing signal when the elevator car is located at an odd landing.

In some examples, the special operating mode is a service mode.

According to a further aspect of the disclosure, there is provided an elevator system comprising: a hoistway, an elevator car disposed in the hoistway, a plurality of landing doors each located at respective landings and configured to provide access to the hoistway, wherein the elevator car is adapted to travel to the respective landings, and the safety system according to any of the examples described above.

In some examples, the first safety chain is connected to one or more of the even landing doors and the second safety chain is connected to one or more of the odd landing doors.

In some examples, when in the special operating mode, the elevator system is configured to deploy a safety brake and/or a safety barrier, optionally an upper balustrade on the elevator car.

By deploying an additional safety mechanism such as a safety brake, safety barrier or upper balustrade, the likelihood of injury to service personnel while performing service procedures such as maintenance or inspection in or around the hoistway is reduced.

In some examples, when in the special operating mode, the elevator car is unable to move.

By preventing the elevator car from moving during the special operation mode, the likelihood of injury to service personnel while performing service procedures such as maintenance or inspection in or around the hoistway is reduced.

According to a further aspect of the disclosure, there is provided a method of operating a safety system for an elevator system. The safety system comprises a first safety chain, a second safety chain, and a controller in communication with the first and second safety chains. The elevator system comprises: a hoistway, a plurality of landing doors configured to provide access to the hoistway and an elevator car provided in the hoistway. The method comprises: in response to a landing door at an even landing opening or the elevator car arriving at an even landing, the first safety chain producing an even landing signal; in response to a landing door at an odd landing opening, or the elevator car arriving at an odd landing, the second safety chain producing an odd landing signal; and the controller automatically instructing the elevator system to enter a special operating mode when the production of the even landing signal and the odd landing signal indicates that the elevator car is located at an even landing and an odd landing door is open, or that the elevator car is located at an odd landing and an even landing door is open.

In some examples, the controller automatically instructs the elevator system to enter the special operating mode in response to simultaneously receiving the even landing signal and the odd landing signal.

In some examples, the controller automatically instructs the elevator system to enter the special operating mode in response to both of the even landing signal and the odd landing signal being present.

In some examples, the first safety chain comprises an even set of sensors and the second safety chain comprises an odd set of sensors. The method further comprises: the even set of sensors indicating that an even landing door has opened, or that the elevator car has arrived at an even landing; in response to the even set of sensors indicating that an even landing door has opened, or that the elevator car has arrive at an even landing, the first safety chain producing the even landing signal; the odd set of sensors indicating that an odd landing door has opened, or that the elevator car has arrived at an odd landing; and in response to the odd set of sensors indicating that an odd landing door has opened, or that the elevator car has arrived at an odd landing, the second safety chain producing the odd landing signal.

In some examples, the method further comprises: in response to being instructed to enter the special operating mode, the elevator system deploying a safety brake and/or an upper balustrade on the elevator car.

According to a yet further aspect of the disclosure, there is provided a computer program product for a controller of a safety system as above, the computer program product including instructions that, when executed by a processor, cause the controller to perform operations comprising: in response to receiving an even landing signal and an odd landing signal, instructing the elevator system to enter a special operating mode.

### BRIEF DESCRIPTION OF THE DRAWINGS

FIG. 1 is a schematic illustration of an elevator system in a building;

FIG. 2 is a schematic illustration of a safety system in accordance with at least one example of the disclosure;

FIG. 3 is a schematic illustration of a part of the safety system of FIG. 2; and

FIG. 4 is a diagram of a method in accordance with at least one example of the disclosure.

### DETAILED DESCRIPTION OF THE INVENTION

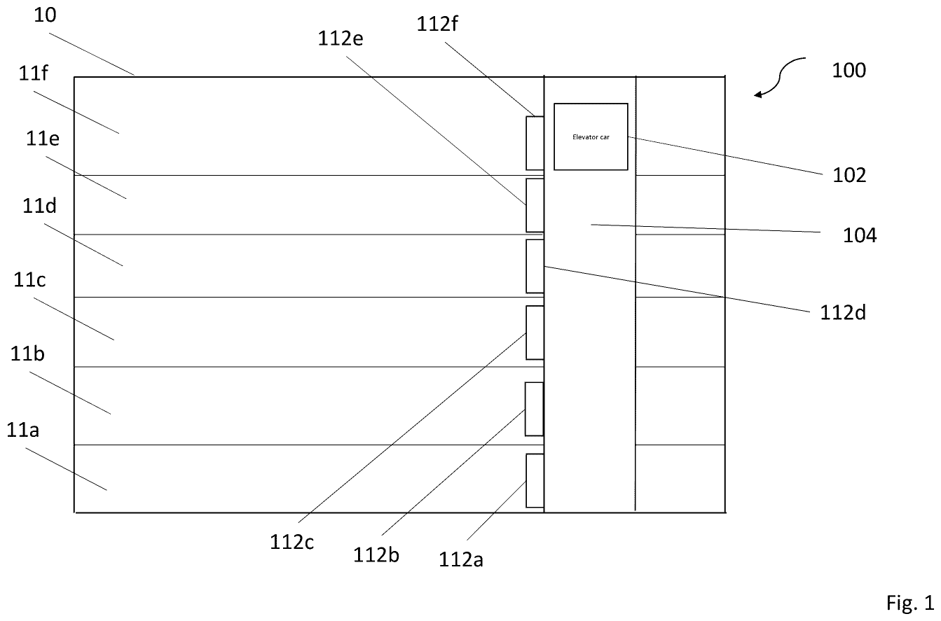

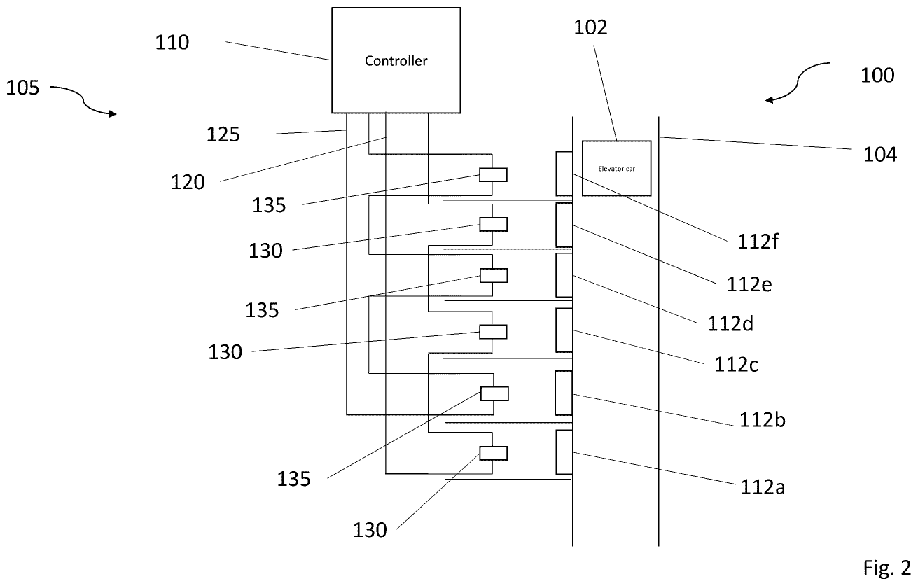

FIGS. 1 and 2 show an elevator system 100 comprising an elevator car 102 in a hoistway 104. In embodiments, the elevator system 100 may comply with the PESSRAL (Programmable Electronic Systems in Safety Related Applications for Lifts) standard. The elevator car 102 is configured to move up and down the hoistway 104 to transport passengers between the different landings 11a-11f in a building 10. It will be understood that a building typically includes a number of different floors and that each floor may have a landing from which the hoistway may be accessed. Alternate landings at which the elevator car is configured to stop may be referred to as even landings and the alternate landings located between the respective even landings may be referred to as odd landings. Although not shown in the drawings, it will be appreciated that the elevator system 100 may comprise other standard components including but not limited to drive means, tension members, a counterweight, a power source and a control panel.

As seen in FIG. 2, which shows the same elevator system 100 as in FIG. 1 but with some elements in more detail, the elevator system 100 comprises a plurality of landing doors 112a-f. Each landing door 112a in the plurality of landing doors 112a-f is located on a different respective landing 11a. The plurality of landing doors 112a-f provide access to the hoistway 104 when open. When a landing door 112a on a landing 11a is closed, no access to the hoistway 104 is possible from that respective landing 11a. It will be understood that the elevator car 102 is also accessible via any of the plurality of landing doors 112a-f when the elevator car 102 is located at that respective landing 11a-f and when both an elevator car door (not shown) and the landing door 112a are open.

The plurality of landing doors 112a-f comprises one or more even landing doors located on even landings of the building 10 and one or more odd landing doors located on odd landings of the building 10. The even landings of the building 10 are the landings with even numbers (i.e. level 0, 2, 4, 6 etc). The odd landings of the building 10 are the landings with odd numbers (i.e. level 1, 3, 5, 7 etc.).

The elevator system 100 comprises a safety system 105. The safety system 105 ensures the safety of service personnel while working in the hoistway 104. The safety system 105 comprises a controller 110 (e.g., a processor-based controller executing a computer program to perform the operations described herein). The elevator system 100 may comprise further controllers, each performing different functions to facilitate the operation of the elevator system 100.

It will be understood that service personnel are personnel charged with carrying out service actions on an elevator system. They are distinct from non-service personnel only in that they perform actions on an elevator system beyond what would be considered “normal use”. The actions which may be performed by service personnel include, but are not limited to, inspection and/or maintenance of the elevator system.

The safety system 105 comprises a first safety chain 120. The first safety chain 120 and the controller 110 are connected such that the controller 110 can receive an even landing signal from the first safety chain 120. The first safety chain 120 is connected to the one or more landing doors 112a, 112c, 112e located on even landings 11a, 11c, 11e of the building 10. The first safety chain 120 may be connected to the one or more landing doors 112a, 112c, 112e via sensors as will be described further below.

The first safety chain 120 is configured to transmit the even landing signal to the controller 110 when any of the one or more even landing doors 112a, 112c, 112e are open. The first safety chain 120 is also configured to transmit the even landing signal to the controller 110 when the elevator car 102 is located at any of the even landings 11a, 11c, 11e.

The safety system 105 comprises a second safety chain 125. The second safety chain 125 and the controller 110 are connected such that the controller 110 can receive an odd landing signal from the second safety chain 125. In embodiments, the second safety chain 125 is connected to one or more landing doors 112b, 112d, 112f located on odd landings 11b, 11d, 11f of the building 10.

The second safety chain 125 is configured to transmit the odd landing signal to the controller 110 when any of the one or more odd landing doors 112b,112d, 112f are open. The second safety chain 125 is also configured to transmit the odd landing signal to the controller 110 when the elevator car 102 is located at any of the odd landings 11b, 11d, 11f.

In examples, the first safety chain 120 comprises an even set of sensors 130. Each sensor in the even set of sensors 130 may be physically adjacent to a respective one of the one or more even landing doors 112a, 112c, 112e.

The even set of sensors 130 automatically produces the even landing signal which is transmitted to the controller 110 by the first safety chain 120 either when any of the one or more even landing doors 112a, 112c, 112e is open, or when the elevator car 102 is located at any of the even landings 11a, 11c, 11e.

In examples, the second safety chain 125 comprises an odd set of sensors 135. Each sensor in the odd set of sensors 135 may be physically adjacent to a respective one of the one or more odd landing doors 112b, 112d, 112f.

The odd set of sensors 135 automatically produces the odd landing signal which is transmitted to the controller 110 by the second safety chain 125 either when any of the one or more odd landing doors 112b, 112d, 112f is open, or when the elevator car 102 is located at any of the odd landings 11b, 11d, 11f.

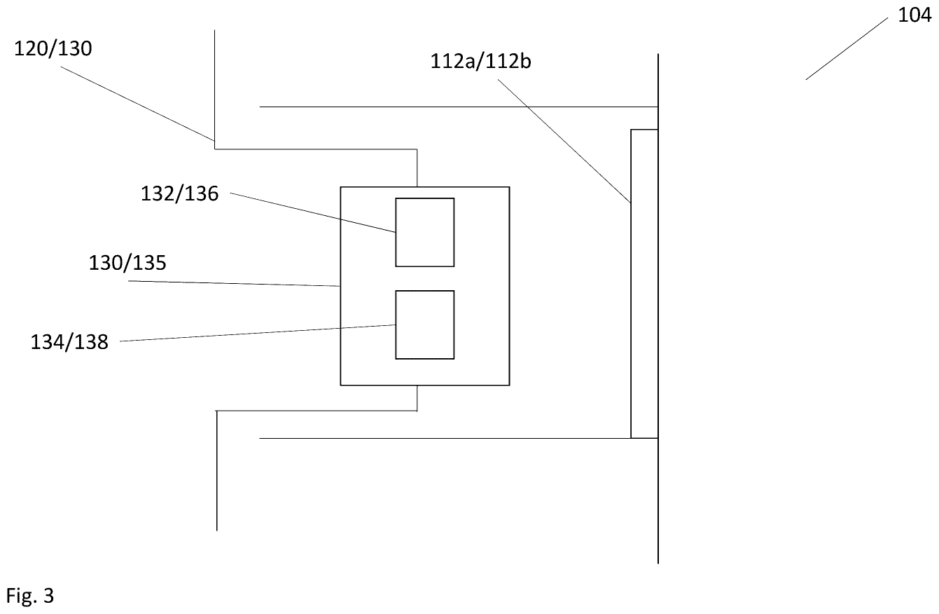

As seen in FIG. 3, which shows a part of a generic safety chain which is common to both the first and second safety chains 120, 125, in examples, the even set of sensors 130 comprises a plurality of even door sensors 132 and a plurality of even landing sensors 134, and the odd set of sensors 135 comprises a plurality of odd door sensors 136 and a plurality of odd landing sensors 138.

In examples, the plurality of even door sensors 132 are configured to produce the even landing signal when any of the even landing doors 112a, 112c, 112e are open; and the plurality of odd door sensors 136 are configured to produce the odd landing signal when any of the odd landing doors 112b,112d, 112f are open.

In some examples the plurality of even door sensors 132 comprise a plurality of override switches (not shown). The plurality of override switches are configured to automatically produce the even landing signal when an even landing door 112a, 112c, 112e is opened by a manual override. The manual override may comprise service personnel overriding a landing door locking mechanism to open an even landing door 112a, 112c, 112e when the elevator car 102 is not located at the landing 11a, 11c, 11f associated with said even landing door 112a, 112c, 112e.

In any example, the plurality of override switches may each comprise an electrical contact (not shown) which is opened or closed such that, when the contact is closed, current may flow through the contact, and when the contact is opened, no current may flow through the contact. The controller 110 may be configured to instruct the elevator system 100 to automatically enter a special operating mode when no current is received from the first safety chain 120 and no current is also received from the second safety chain 125, for example when the contact of one override switch has been opened indicating that an even landing door has been opened by a manual override and thus providing no current via the first safety chain 120, while the second safety chain 125 indicates that the elevator car 102 is located at an odd landing.

In some examples, the plurality of override switches produce the even landing signal in response to service personnel inserting a key into a lock and turning the key in the lock. In examples, turning the key in the lock may move the contact to the open position such that no current may flow through the contact. In other examples, the plurality of override switches may produce the even landing signal in response to service personnel pushing a button or entering a code into a number pad. In examples, pressing the button or entering the code may move the contact to the open position such that no current may flow through the contact. In alternative examples, turning the key, pressing the button or entering the code may move the contact into the closed position such that current may flow through the contact.

In addition or alternatively, in some examples the plurality of odd door sensors 136 comprise a plurality of override switches (not shown). The plurality of override switches are configured to automatically produce the odd landing signal when service personnel overrides a landing door locking mechanism to open an odd landing door when the elevator car 102 is not located at the landing associated with said odd landing door.

In some examples, the plurality of override switches produce the odd landing signal in response to service personnel inserting a key into a lock and turning the key in the lock. In examples, turning the key in the lock may move the contact to the open position such that no current may flow through the contact. In other examples, the plurality of override switches may produce the odd landing signal in response to service personnel pushing a button or entering a code into a number pad. In examples, pressing the button or entering the code may move the contact to the open position such that no current may flow through the contact. In alternative examples, turning the key, pressing the button or entering the code may move the contact into the closed position such that current may flow through the contact.

In examples, the plurality of even landing sensors 134 comprise a plurality of proximity sensors (not shown). The plurality of proximity sensors are configured to produce the even landing signal in response to the elevator car 102 being located at an even landing. In some examples, the plurality of proximity sensors may be disposed inside the hoistway 104 such that they detect when the elevator car 102 is located at an even landing. In other examples, the plurality of proximity sensors may be connected to an elevator control system, which provides updates to the plurality of proximity sensors on the location of the elevator car 102.

In examples, the plurality of odd landing sensors 138 comprise a plurality of proximity sensors (not shown). The plurality of proximity sensors are configured to produce the odd landing signal in response to the elevator car 102 being located at an odd landing. In some examples, the plurality of proximity sensors may be disposed inside the hoistway 104 such that they detect when the elevator car 102 is located at an odd landing. In other examples, the plurality of proximity sensors may be connected to an elevator control system, which provides updates to the plurality of proximity sensors on the location of the elevator car 102.

The even landing signal and the odd landing signal in some examples comprises a change in the normal output from the even set of sensors 130 and the odd set of sensors 135 respectively.

In examples, the normal output from the even set of sensors 130 and the odd set of sensors 135 may be a positive signal. In examples, the positive signal may be the flow of electric current. In other examples, the positive signal may be a constant stream of data sent wirelessly. In such examples, the even landing signal and the odd landing signal may comprise the electric current no longer flowing, or the constant stream of data sent wirelessly being interrupted.

In other examples, the normal output from the even set of sensors 130 and the odd set of sensors 135 may be a negative signal. In examples, the negative signal may be lack of flow of electric current, or the lack of data sent wirelessly. In such examples, the override signal may comprise the flow of electric current or a stream of data sent wirelessly.

In examples, both of the plurality of proximity sensors and the plurality of override sensors can produce the even landing signal or odd landing signal. In examples where the even landing signal and/or the odd landing signal comprise electric current no longer flowing, the even landing signal and/or the odd landing signal may be produced by a break in the electrical circuit at the plurality of proximity sensors and/or the plurality of override sensors.

In examples, the controller 110 monitors the first safety chain 120. The controller 110 may monitor the electrical current flowing through the first safety chain 120 so that it can detect when the even landing signal is produced.

In examples, the controller 110 monitors the second safety chain 125. The controller 110 monitors the electrical current flowing through the second safety chain 125 so that it can detect when the odd landing signal is produced.

In normal operation, at least in some examples, electrical current will be running through at least one of the first safety chain 120 and the second safety chain 125 at any time. In normal operation, when the elevator car 102 is stopping at landings to service landing calls, the landing doors will only open at the landings at which the elevator has stopped such that the controller 110 will receive only one of the even landing signal and the odd landing signal at any one time. In some examples however, if the controller 110 receives the even landing signal and the odd landing signal at the same time (for example when electrical current is not running through either of the first safety chain 120 and the second safety chain 125) the controller 110 automatically causes the elevator system 100 to enter a special operation mode. In some examples, the controller 110 is configured to automatically instruct the elevator system 100 to enter the special operating mode in response to both of the even landing signal and the odd landing signal being present.

In examples, the special operation mode is a service mode. In embodiments, the service mode is a maintenance mode and/or an inspection mode, which is associated with a PESSRAL safety system.

In the special operation mode, it is assumed that service personnel are working in the hoistway 104. Therefore, additional safety measures are implemented to protect service personnel when the elevator system 100 is in the special operation mode.

In some examples, when in the special operation mode, the elevator system 100 is configured to prevent the elevator car 102 from moving. The elevator system 100 may deploy a safety brake and/or a safety barrier such as an upper balustrade that is disposed on the roof of the elevator car 102. The upper balustrade may prevent service personnel working atop the elevator car 102 from falling into the hoistway 104. The safety brake may prevent the elevator car 102 from moving and may not be overridden until the elevator system 100 re-enters the normal mode.

In some examples, elevator call buttons on landings in the building are disabled when the elevator system 100 is in the special operating mode.

In some examples, on entering the special operation mode automatically a safe distance limit between the top of the elevator car 102 and the top of the hoistway 104 is set, and the elevator car 102 is prevented from moving past this limit towards the top of the hoistway 104.

In some examples, on entering the special operation mode, the elevator system 100 may deploy additional lighting and sound systems to any of the hoistway 104, the elevator car 102 and the plurality of landing doors 112a-f. The lighting and sound systems may alert nearby people that servicing is being carried out, and may assist the service personnel in performing their duties.

When in the special operation mode, the elevator system 100 is in a safe state for the hoistway 104 to be accessed and for service procedures such as maintenance or inspection to be carried out.

In some examples, the controller 110 may instruct the elevator system 100 to return to the normal mode. In such examples, the controller 110 may instruct the elevator system 100 to re-enter the normal operation mode when either of the even landing signal and the odd landing signal is no longer received by the controller 110. In other examples, the controller 110 may instruct the elevator system 100 to re-enter the normal operation mode when the normal output is received from either of the even set of sensors 130 and the odd set of sensors 135.

In some examples, the plurality of override switches may produce the normal output in response to the key being removed from the lock.

In other examples, the elevator system 100 may return to the normal mode following further instruction from service personnel.

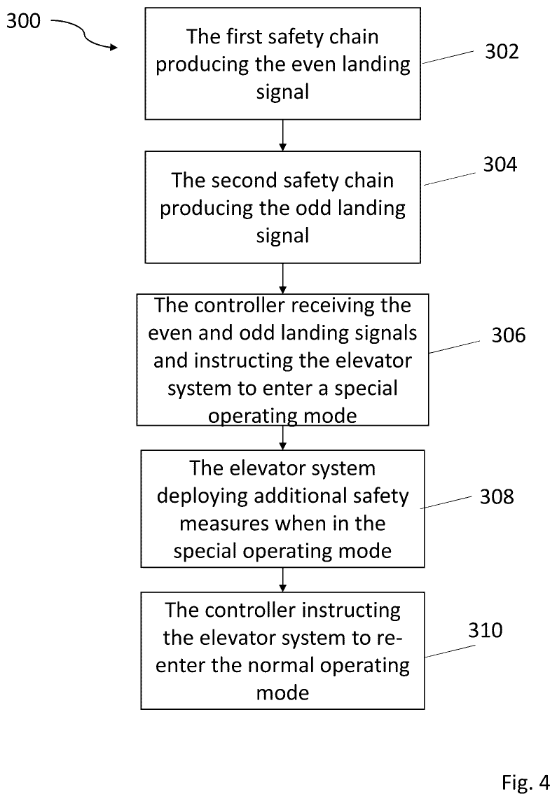

FIG. 4 depicts a method 300 of operating the safety system 105 of the elevator system 100 described above is also disclosed.

The method 300 comprises the first safety chain 120 producing the even landing signal (step 302) in response to the even landing door being opened, or in response to the elevator car 102 arriving at the even landing. In examples, the even set of sensors 130 may produce the even landing signal.

The method 300 further comprises the second safety chain 125 producing the odd landing signal (step 304) in response to the odd landing door being opened, or in response to the elevator car 102 arriving at the odd landing. In examples, the odd set of sensors 135 may produce the odd landing signal.

The method 300 further comprises the controller 110 automatically instructing the elevator system 100 to enter the special operating mode in response to the controller 110 receiving both of the even landing signal and the odd landing signal (step 306). In examples, the controller 110 automatically instructs the elevator system 100 to enter the special operating mode in response to the controller 110 simultaneously receiving both of the even landing signal and the odd landing signal. In some examples, “automatically instructing” is taken to mean “immediately instructing”. In some examples, the controller 110 automatically instructs the elevator system 100 to enter the special operating mode in response to both of the even landing signal and the odd landing signal being present.

In examples, the method 300 further comprises the elevator system 100 deploying additional safety measures in response to entering the special operating mode (step 308). In some examples, the additional safety measures comprise deploying a safety brake on the elevator car 102, activating lighting and sound systems in the hoistway 104, on the elevator car 102 or at the plurality of landing doors 112a-f, and deploying a guard rail, which may be an upper balustrade, on the elevator car 102.

In examples, the method 300 further comprises the controller 110 instructing the elevator system 100 to re-enter the normal operating mode in response to the first safety chain 120 and/or the second safety chain 125 no longer producing the even landing signal or the odd landing signal respectively (step 310). In some examples, the method 300 further comprises the controller 110 instructing the elevator system 100 to re-enter the normal operating mode in response to the first safety chain 120 and/or the second safety chain 125 producing the normal output.

It will be appreciated by those skilled in the art that the disclosure has been illustrated by describing one or more examples thereof, but is not limited to these examples; many variations and modifications are possible, within the scope of the accompanying claims. For example, the elevator car may be used in a roped or ropeless elevator system, or another type of conveyance system.

What is claimed is:

1. A safety system (105) for an elevator system (100), the safety system comprising:
a first safety chain (120);
a second safety chain (125); and
a controller (110) in communication with the first and second safety chains,
the elevator system comprising a hoistway (104), a plurality of landing doors (112a-f) configured to provide access to the hoistway and an elevator car (102) provided in the hoistway,
wherein the first safety chain is configured to produce an even landing signal when the elevator car is located at an even landing (11a, 11c, 11e), and/or when an even landing door (112a, 112c, 112e) located on an even landing is open,
wherein the second safety chain is configured to produce an odd landing signal when the elevator car is located at an odd landing (11b, 11d, 11f), and/or when an odd landing door (112b,112d, 112f) located on an odd landing is open,
wherein the controller is configured to automatically instruct the elevator system to enter a special operating mode when the production of the even landing signal and the odd landing signal indicates that the elevator car is located at an even landing and an odd landing door is open, or that the elevator car is located at an odd landing and an even landing door is open.

2. The safety system (105) of claim 1, wherein the first safety chain (120) is connected to the controller (110) by a wired connection or by a wireless connection, and/or
wherein the second safety chain (125) is connected to the controller by a wired connection or by a wireless connection.

3. The safety system (105) of claim 1, wherein the first safety chain (120) comprises an even set of sensors (130) and the second safety chain comprises an odd set of sensors (135),
wherein the even set of sensors is configured to cause the even landing signal to be produced when the elevator car (102) is located at an even landing (11a, 11c, 11e), and/or when an even landing door (112a, 112c, 112e) is open, and
wherein the odd set of sensors is configured to cause the odd landing signal to be produced when the elevator car is located at an odd landing (11b, 11d, 11f), and/or when an odd landing door (112b,112d, 112f) is open.

4. The safety system (105) of claim 3, wherein the even set of sensors (130) comprises a plurality of even door sensors (132) configured to produce an even landing signal when an even landing door (112a, 112c, 112e) is open, and/or
wherein the odd set of sensors (135) comprises a plurality of odd door sensors (136) configured to produce an odd landing signal when an odd landing door (112b,112d, 112f) is open.

5. The safety system (105) of claim 3, wherein the even set of sensors (130) comprises a plurality of even landing sensors (134) configured to produce an even landing signal when the elevator car (102) is located at an even landing (11a, 11c, 11e), and/or
wherein the odd set of sensors (135) comprises a plurality of odd landing sensors (136) configured to produce an odd landing signal when the elevator car is located at an odd landing (11b, 11d, 11f).

6. The safety system (105) of claim 1, wherein the special operating mode is a service mode.

7. An elevator system (100), comprising:
a hoistway (104);
an elevator car (102) disposed in the hoistway;
a plurality of landing doors (112a-f) each located at respective landings (11a-11f) and configured to provide access to the hoistway, wherein the elevator car is adapted to travel to the respective landings; and
the safety system (105) of claim 1.

8. The elevator system (100) of claim 7, wherein the first safety chain (120) is connected to one or more of the even landing doors (112a, 112c, 112e) and the second safety chain (125) is connected to one or more of the odd landing doors (112b,112d, 112f).

9. The elevator system (100) of claim 7, wherein when in the special operating mode, the elevator system is configured to deploy a safety brake and/or a safety barrier, optionally an upper balustrade on the elevator car (102).

10. The elevator system (100) of claim 7, wherein when in the special operating mode, the elevator car (102) is unable to move.

11. A method (300) of operating a safety system (105) for an elevator system (100), the safety system comprising:
a first safety chain (120);
a second safety chain (125);
and a controller (110) in communication with the first and second safety chains;
the elevator system comprising: a hoistway (104), a plurality of landing doors (112a-f) configured to provide access to the hoistway and an elevator car (102) provided in the hoistway;
the method comprising:
in response to a landing door (112a, 112c, 112e) at an even landing opening or the elevator car arriving at an even landing (11a, 11c, 11e), the first safety chain producing an even landing signal;
in response to a landing door (112b,112d, 112f) at an odd landing opening, or the elevator car arriving at an odd landing (11b, 11d, 11f), the second safety chain producing an odd landing signal; and
the controller automatically instructing the elevator system to enter a special operating mode when the production of the even landing signal and the odd landing signal indicates that the elevator car is located at an even landing and an odd landing door is open, or that the elevator car is located at an odd landing and an even landing door is open.

12. The method of claim 11, wherein the controller (110) automatically instructs the elevator system (100) to enter the special operating mode in response to: simultaneously receiving the even landing signal and the odd landing signal; and/or
both of the even landing signal and the odd landing signal being present.

13. The method (300) of claim 11, wherein the first safety chain (120) comprises an even set of sensors (130) and the second safety chain (125) comprises an odd set of sensors (135);
the method further comprising:
in response to the even set of sensors indicating that an even landing door (112a, 112c, 112e) has opened, or that the elevator car (102) has arrived at an even landing (11a, 11c, 11e), the first safety chain producing the even landing signal; and
in response to the odd set of sensors indicating that an odd landing door (112b,112d, 112f) has opened, or that the elevator car has arrived at an odd landing (11b, 11d, 11f), the second safety chain producing the odd landing signal.

14. The method (300) of claim 11, comprising:
in response to being instructed to enter the special operating mode, the elevator system (100) deploying a safety brake and/or a safety barrier, optionally an upper balustrade, on the elevator car (102).

15. A computer program product for a controller (110) of a safety system (105) as claimed in claim 1, the computer program product including instructions that, when executed by a processor, cause the controller to perform operations comprising:
in response to receiving an even landing signal and an odd landing signal, instructing the elevator system to enter a special operating mode.
